(19) United States
(12) Patent Application Publication
(10) Pub. No.: US 2026/0086361 A1
(43) Pub. Date: Mar. 26, 2026

(54) Localized Dimming at Wearable Optical System

(71) Applicant: Magic Leap, Inc., Plantation, FL (US)

(72) Inventors: Rémi Samuel AUDFRAY, San Francisco, CA (US); Margaret Louise JOHNSON, Aspen, CO (US); Gabriel CIUCULIN, Weston, FL (US)

(73) Assignee: Magic Leap, Inc., Plantation, FL (US)

(21) Appl. No.: 18/888,089

(22) Filed: Sep. 17, 2024

Related U.S. Application Data
(63) Continuation of application No. PCT/US2022/022876, filed on Mar. 31, 2022.

(51) Int. Cl. G02B 27/01

(52) U.S. Cl. CPC G02B 27/0172; G02B 2027/0118; G02B 2027/0138; G02B 2027/014; G02B 2027/0178

(57) ABSTRACT

Described herein are systems and methods that provide localized dimming of world light emanating from world light sources. An optical system can include left and right dimmers. The optical system can also include left and right cameras configured to capture a left and right brightness images. The optical system can generate a 3D brightness source map based on the left and right brightness images, and generate left and right 2D brightness maps based on the 3D brightness source map. The optical can compute left and right dimming values for the left and right dimmers based on the left and right 2D brightness maps, and adjust the left and right dimmers to reduce an intensity of the world light.

### BACKGROUND OF THE INVENTION

This application is a continuation of International Patent Application No. PCT/US2022/022876, filed Mar. 31, 2022, entitled “LOCALIZED DIMMING AT WEARABLE OPTICAL SYSTEM,” the entire disclosure of which is hereby incorporated by reference, for all purposes, as if fully set forth herein.

Modern computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality, or “VR,” scenario typically involves presentation of digital or virtual image information without transparency to other actual real-world visual input; an augmented reality, or “AR,” scenario typically involves presentation of digital or virtual image information as an augmentation to visualization of the actual world around the user.

Despite the progress made in these display technologies, there is a need in the art for improved methods, systems, and devices related to augmented reality systems, particularly, display systems.

### SUMMARY OF THE INVENTION

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is a method of operating an optical system, the method comprising: receiving, at the optical system, light associated with a world object; capturing a left brightness image and a right brightness image using a left camera and a right camera of the optical system, respectively; generating a 3D brightness source map based on the left brightness image and the right brightness image; generating a left 2D brightness map and a right 2D brightness map based on the 3D brightness source map; computing left dimming values and right dimming values based on the left 2D brightness map and the right 2D brightness map, respectively; and adjusting a left dimmer and a right dimmer of the optical system based on the left dimming values and the right dimming values, respectively, so as to reduce an intensity of the light associated with the world object.

Example 2 is the method of example(s) 1, further comprising: projecting virtual image light onto a left eyepiece and a right eyepiece of the optical system.

Example 3 is the method of example(s) 2, wherein the left dimmer and the right dimmer are positioned on a world side of the left eyepiece and the right eyepiece, respectively.

Example 4 is the method of example(s) 2, wherein the left dimmer and the right dimmer are positioned on a user side of the left eyepiece and the right eyepiece, respectively.

Example 5 is the method of example(s) 1-4, wherein the left camera and the right camera directly capture multi-channel images that are converted into the left brightness image and a right brightness image, respectively.

Example 6 is the method of example(s) 1-5, wherein the left camera and the right camera directly capture the left brightness image and the right brightness image, respectively.

Example 7 is the method of example(s) 1-6, wherein the left dimming values and the right dimming values indicate portions of a field of view of the optical system that are to be at least partially dimmed by the left dimmer and the right dimmer, respectively.

Example 8 is the method of example(s) 1-7, wherein the 3D brightness source map is further generated based on a predetermined distance between the left camera and the right camera.

Example 9 is the method of example(s) 1-8, wherein generating the left 2D brightness map and the right 2D brightness map based on the 3D brightness source map includes predicting positions of a user's left eye and a user's right eye, respectively, with respect to the 3D brightness source map when the optical system is in use.

Example 10 is a non-transitory computer-readable medium comprising instructions that, when executed by one or more processors, cause the one or more processors to perform operations for operating an optical system, the operations comprising: capturing a left brightness image and a right brightness image using a left camera and a right camera of the optical system based on receiving light associated with a world object, respectively; generating a 3D brightness source map based on the left brightness image and the right brightness image; generating a left 2D brightness map and a right 2D brightness map based on the 3D brightness source map; computing left dimming values and right dimming values based on the left 2D brightness map and the right 2D brightness map, respectively; and adjusting a left dimmer and a right dimmer of the optical system based on the left dimming values and the right dimming values, respectively, so as to reduce an intensity of the light associated with the world object.

Example 11 is the non-transitory computer-readable medium of example(s) 10, wherein the operations further comprise: projecting virtual image light onto a left eyepiece and a right eyepiece of the optical system.

Example 12 is the non-transitory computer-readable medium of example(s) 11, wherein the left dimmer and the right dimmer are positioned on a world side of the left eyepiece and the right eyepiece, respectively.

Example 13 is the non-transitory computer-readable medium of example(s) 10-12, wherein the left camera and the right camera directly capture multi-channel images that are converted into the left brightness image and a right brightness image, respectively.

Example 14 is the non-transitory computer-readable medium of example(s) 10-13, wherein the left dimming values and the right dimming values indicate portions of a field of view of the optical system that are to be at least partially dimmed by the left dimmer and the right dimmer, respectively.

Example 15 is the non-transitory computer-readable medium of example(s) 10-14, wherein the 3D brightness source map is further generated based on a predetermined distance between the left camera and the right camera.

Example 16 is the non-transitory computer-readable medium of example(s) 10-15, wherein generating the left 2D brightness map and the right 2D brightness map based on the 3D brightness source map includes predicting positions of a user's left eye and a user's right eye, respectively, with respect to the 3D brightness source map when the optical system is in use.

Example 17 is an optical system comprising, a left camera and a right camera configured to capture a left brightness image and a right brightness image, respectively; a left dimmer and a right dimmer configured to reduce an intensity of light associated with a world object in accordance with left dimming values and right dimming values, respectively; and one or more processors communicatively coupled to the left camera, the right camera, the left dimmer, and the right dimmer, wherein the one or more processors are configured to: generate a 3D brightness source map based on the left brightness image and the right brightness image; generate a left 2D brightness map and a right 2D brightness map based on the 3D brightness source map; compute the left dimming values and the right dimming values based on the left 2D brightness map and the right 2D brightness map, respectively; and adjust the left dimmer and the right dimmer based on the left dimming values and the right dimming values, respectively, so as to reduce the intensity of the light associated with the world object.

Example 18 is the optical system of example(s) 17, further comprising: a left eyepiece and a right eyepiece in alignment with the left dimmer and the right dimmer, respectively.

Example 19 is the optical system of example(s) 18, wherein the one or more processors are configured to project virtual image light onto the left eyepiece and the right eyepiece.

Example 20 is the optical system of example(s) 18, wherein the left dimmer and the right dimmer are positioned on a world side of the left eyepiece and the right eyepiece, respectively.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates a wearable device and a corresponding scene as viewed through a wearable device.

FIG. 2 illustrates an example wearable device incorporating a segmented dimmer in alignment with an eyepiece.

FIG. 3 illustrates an example wearable device with an eyepiece and a pixelated dimming element consisting of a spatial grid of dimming areas.

FIGS. 4A-4C illustrate examples of dimmer-specific dimming values that may be computed for different light source positions.

FIGS. 5A-5D illustrate example data that may be captured, generated, or computed to obtain sets of left and right dimming values for dimmers of a wearable device.

FIGS. 6A and 6B illustrate examples of changes of a light sensitivity region of an eye in high and low ambient light.

FIGS. 7A-7C illustrate modified computed dimming values based on ambient light conditions.

FIG. 8 illustrates a schematic view of an example wearable system.

FIG. 9 illustrates a method of operating an optical system.

FIG. 10 illustrates an example computer system comprising various hardware elements.

### DETAILED DESCRIPTION OF THE INVENTION

Wearable optical systems and devices, such as optical see through (OST) augmented reality (AR) devices, can be difficult to operate in extreme light conditions. For example, when a bright light source (e.g., the sun) is present, the light source can irritate the user's eyes and darker areas in the device's field of view become difficult for the user to see. Furthermore, when virtual content is being displayed at a wearable optical system, the virtual content that overlaps with the bright light source can be overpowered by the world light associated with the bright light source, while the virtual content displayed elsewhere in the device's field of view may be unobservable due to the potential irritation to the user's eyes due to the world light.

Embodiments of the present invention solve these and other problems by dimming the world light at different spatial locations within the device's field of view using left and right segmented dimmers. Embodiments provide eye protection from high brightness light sources while retaining low opacity for areas with low light. In some embodiments, data captured by one or more cameras mounted on the wearable device is used to determine the amount of light each eye is exposed to and, based on that information, drive the segmented dimming. Embodiments may include a two camera configuration in which left and right cameras are positioned near (e.g., to the outside of) the dimmers, as well as a single camera configuration in which a camera is positioned between the dimmers or elsewhere along the wearable device.

Since the camera(s) are not aligned with the user's eyes, the data captured by the camera(s) is used to render a three-dimensional (3D) brightness source map that identifies the direction, magnitude, and/or position of each light source in the device's environment, and thereafter the source map can be used to generate brightness maps from the perspective of the user's eyes. For example, the values in the 3D brightness source map may be mapped onto the surface areas of the dimmers based on predicted positions of the user's eyes, resulting in a two-dimensional (2D) brightness map for each segmented dimmer.

In some embodiments, the 2D brightness maps are used to compute dimming values or dimming amounts that are applied to the dimmers. In some instances, a proportional dimming scheme is employed in which the amount of dimming at each pixel of the segmented dimmers is proportional to the magnitude of the brightness value indicated in the 2D brightness maps. In some instances, a threshold dimming scheme is employed in which dimming is only applied at pixels where the magnitude of the brightness indicated in the 2D brightness maps is above a threshold value. Upon computing the dimming values, the dimmers are caused to perform pixel-wise dimming in accordance with the computed dimming values until updated dimming values are provided.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

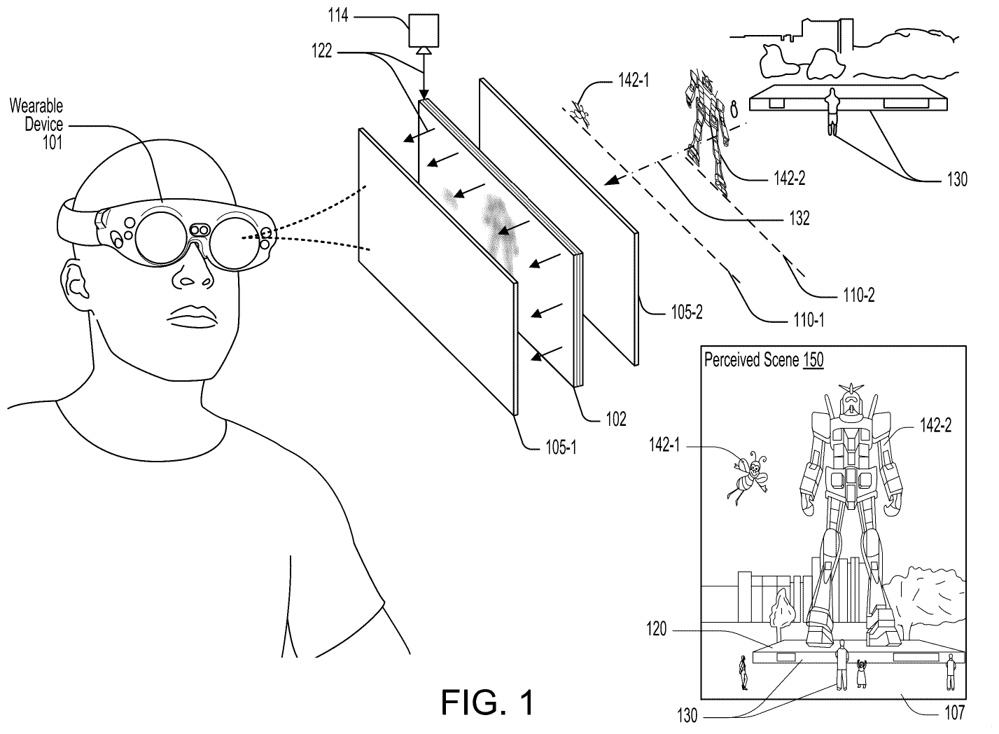

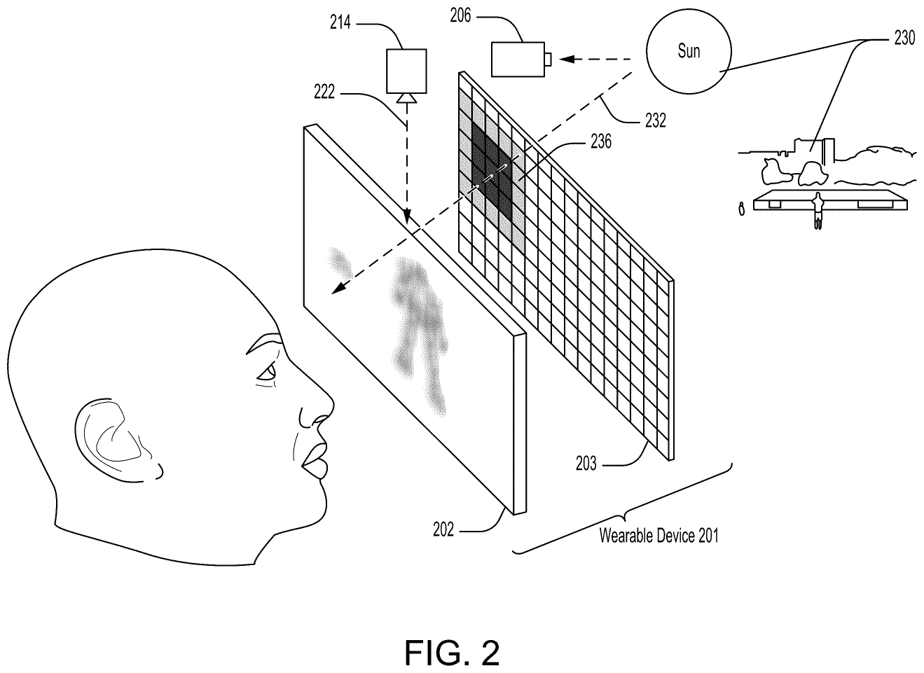

The figures herein follow a numbering convention in which the first digit or digits correspond to the figure number and the remaining digits identify an element or component in the figure. Similar elements or components between different figures may be identified by the use of similar digits. For example, 101 may reference element “101” in FIG. 1, and a similar element may be referenced as 201 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates a wearable device 101 and a corresponding scene 150 as viewed through wearable device 101, according to some embodiments of the present disclosure. Scene 150 is depicted wherein a user of an AR technology sees a real-world park-like setting 107 featuring various real-world objects 130 such as people, trees, buildings in the background, and a real-world concrete platform 120. In addition to these items, the user of the AR technology also perceives that they “see” various virtual objects 142 such as a robot statue 142-2 standing upon the real-world concrete platform 120, and a cartoon-like avatar character 142-1 flying by, which seems to be a personification of a bumble bee, even though these elements (character 142-1 and statue 142-2) do not exist in the real world. Due to the extreme complexity of the human visual perception and nervous system, it is challenging to produce a virtual reality (VR) or AR technology that facilitates a comfortable, natural-feeling, rich presentation of virtual image elements amongst other virtual or real-world imagery elements.

During operation, a projector 114 of wearable device 101 may project virtual image light 122 (i.e., light associated with virtual content) onto an eyepiece 102 of wearable device 101, which may cause a light field (i.e., an angular representation of virtual content) to be projected onto a retina of a user's eye in a manner such that the user perceives the corresponding virtual content as being positioned at some location within an environment of the user. For example, virtual image light 122 injected into eyepiece 102 and outcoupled by eyepiece 102 toward the user's eye may cause the user to perceive character 142-1 as being positioned at a first virtual depth plane 110-1 and statue 142-2 as being positioned at a second virtual depth plane 110-2. The user perceives the virtual content along with world light 132 corresponding to one or more world objects 130, such as platform 120.

In some embodiments, wearable device 101 may include various lens assemblies or other optical structures. In the illustrated example, wearable device 101 includes a first lens assembly 105-1 positioned on the user side of eyepiece 102 (the side of eyepiece 102 closest to the eye of the user) and a second lens assembly 105-2 positioned on the world side of eyepiece 102 (the side of eyepiece 102 furthest from the eye of the user). Each of lens assemblies 105-1, 105-2 may be configured to apply optical power to the light passing therethrough to converge and/or diverge light in a desired manner. While FIG. 1 shows a single projector 114 and single corresponding optical stack (including eyepiece 102 and lens assemblies 105), it is to be understood that wearable device 101 may include an optical stack for each eye with a single or multiple projectors configured to inject virtual image light into the respective optical stack(s).

FIG. 2 illustrates an example wearable device 201 incorporating a segmented dimmer 203 (or simply “dimmer”) in alignment with an eyepiece 202, according to some embodiments of the present disclosure. In some embodiments, segmented dimmer 203 may be transparent or semi-transparent when wearable device 201 is in an inactive mode or an off mode such that a user may view one or more world objects 230 when looking through eyepiece 202 and segmented dimmer 203. As illustrated, eyepiece 202 and dimmer 203 may be arranged in a side-by-side configuration and may form a device field of view that a user sees when looking through eyepiece 202 and dimmer 203. Although FIG. 2 illustrates a single eyepiece 202 and a single dimmer 203 (for illustrative reasons), it is to be understood that wearable device 201 may include two eyepieces and two dimmers, one for each eye of a user.

During operation, dimmer 203 may be adjusted to reduce an intensity of a world light 232 associated with world objects 230 impinging on dimmer 203, thereby producing a dimmed area 236 within the system field of view. Dimmed area 236 may be a portion or subset of the device field of view, and may be partially or completely dimmed. Dimmer 203 may be adjusted according to a plurality of spatially-resolved dimming values, which includes dimming values for dimmed area 236. Furthermore, during operation of wearable device 201, projector 214 may project a virtual image light 222 (i.e., light associated with virtual content) onto eyepiece 202 which may be observed by the user along with world light 232. As described in reference to FIG. 1, projecting virtual image light 222 onto eyepiece 202 may cause a light field to be projected onto the user's retina in a manner such that the user perceives the corresponding virtual content as being positioned at some location within the user's environment.

In some embodiments, wearable device 201 may include a camera 206 (alternatively referred to as a “light sensor”) configured to detect world light 232 and to produce a corresponding image (alternatively referred to as a “brightness image”). In one example, wearable device 201 may include left and right cameras (e.g., camera 206) positioned near left and right dimmers (e.g., dimmer 203), respectively. For each of the left and right sides, camera 206 may be positioned such that world light 232 detected by camera 206 is computationally relatable to the world light 232 that impinges on the respective (left or right) dimmer 203 and/or eyepiece 202. As described herein, the brightness images captured by the left and right cameras (alternatively referred to as “left brightness image” and “right brightness image”, respectively) may be combined and analyzed in such a way that left and right 2D brightness maps that directly correspond to the surfaces of the left and right dimmers and/or the perspectives of the user's left and right eyes, respectively, may be generated.

In the illustrated example, the dimming values for dimmer 203 are computed so as to align dimmed area 236 with world light 232 associated with the sun, thereby protecting the user's eyes and improving the AR experience. Specifically, camera 206 may detect world light 232 associated with the sun, which may be used to further determine a direction and/or a portion of the device field of view at which world light 232 associated with the sun passes through dimmer 203. In response, dimmer 203 may be adjusted to set dimmed area 236 to cover a portion of the device field of view corresponding to the detected world light. As illustrated, dimmer 203 may be adjusted so as to reduce the intensity of world light 232 at the center of dimmed area 236 at a greater amount than the extremities of dimmed area 236.

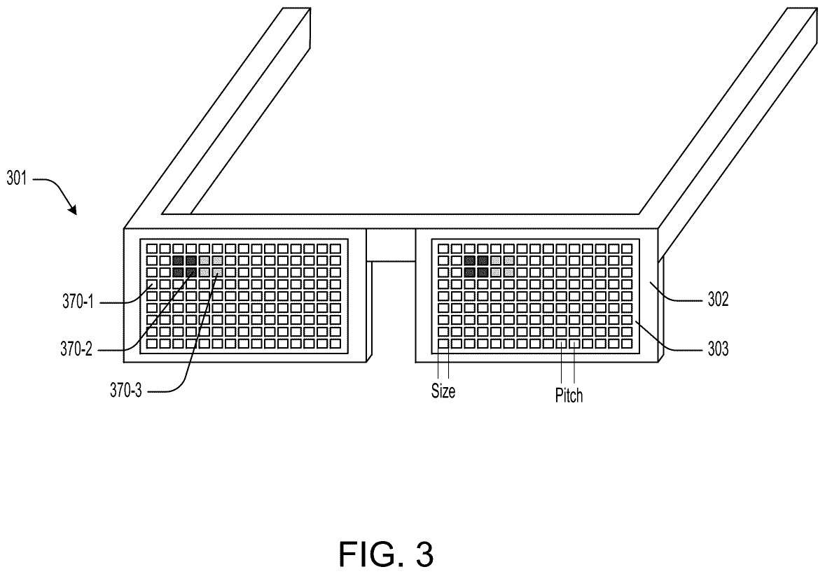

FIG. 3 illustrates an example wearable device 301 with an eyepiece 302 and a pixelated dimming element (i.e., dimmer 303) for each of the left and right sides of wearable device 301, according to some embodiments of the present disclosure. Each dimmer 303 may consist of a spatial grid of dimming areas (i.e., pixels 370) that can have various levels of dimming. Each of pixels 370 may have an associated size (i.e., width) and an associated spacing (i.e., pitch). It is to be understood that the quantity of pixels 370 in each dimmer 303 may be greater or less than the illustrated example (e.g., each dimmer 303 may include a 1028×1028 grid of pixels, a 500×1000 grid of pixels, etc.). As illustrated, the spatial grid of dimming elements may include one or more clear pixels 370-1 providing complete transmission of incident light, one or more fully dark pixels 370-2 providing complete dimming of incident light, and one or more intermediate dark pixels 370-3 providing partial dimming of incident light.

Adjacent pixels 370 within dimmer 303 may be bordering (e.g., when the pitch is equal to the size) or may be separated by gaps (e.g., when the pitch is greater than the size). In various embodiments, dimmer 303 may employ liquid crystal technology such as dye doped or guest host liquid crystals, twisted nematic (TN) or vertically aligned (VA) liquid crystals, or ferroelectric liquid crystals. In some embodiments, dimmer 303 may comprise an electrochromic device. In some implementations, dimmer 303 may employ electrically controlled birefringence (ECB) technology, such as an ECB cell, among other possibilities.

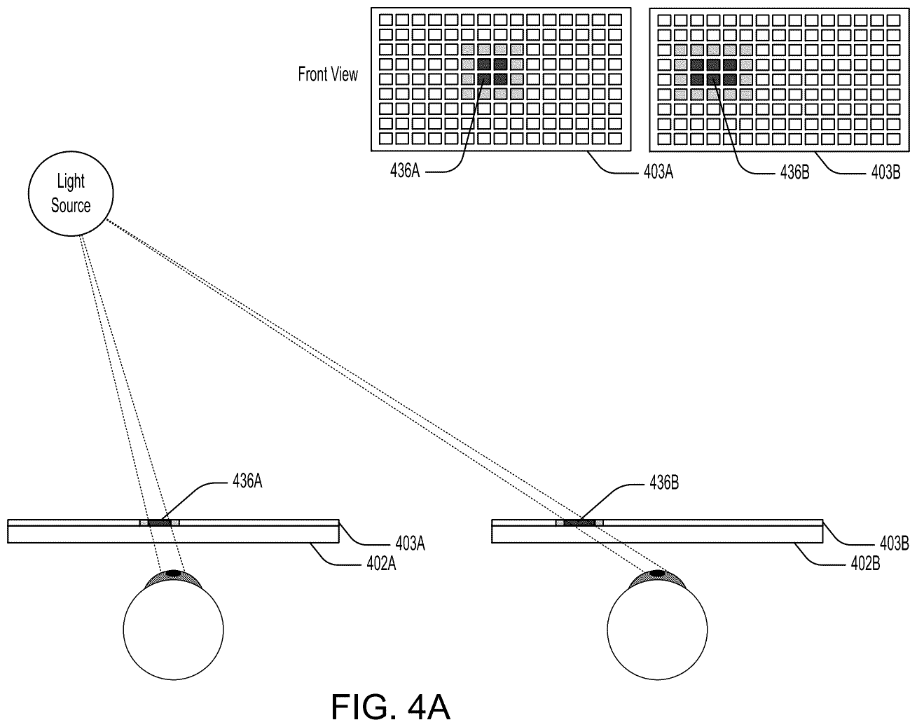

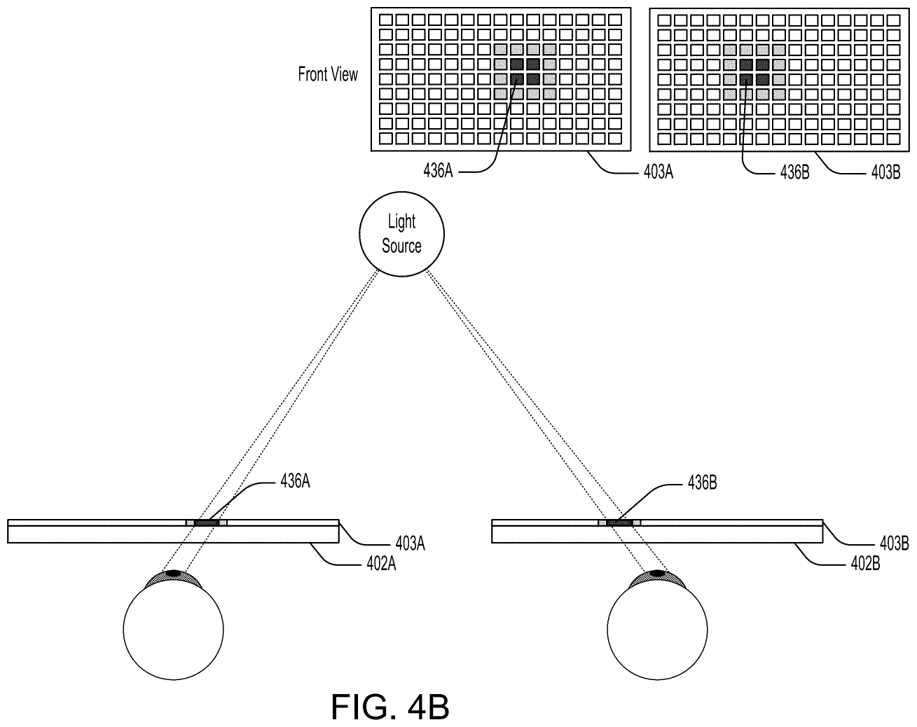

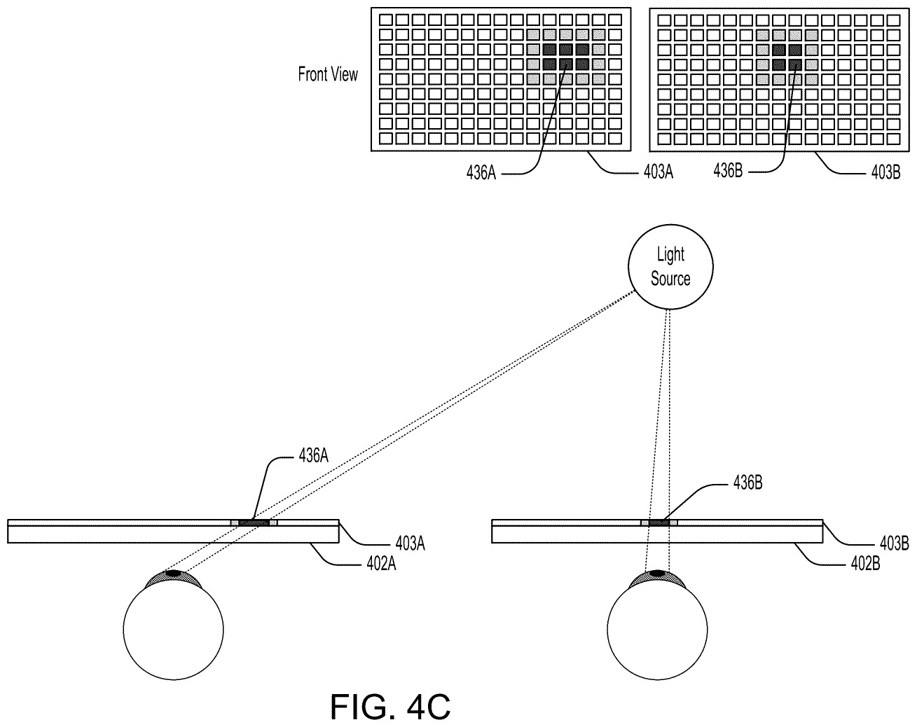

FIGS. 4A-4C illustrate examples of dimmer-specific dimming values that may be computed for different light source positions, according to some embodiments of the present disclosure. In the illustrated examples, the wearable device includes a left dimmer 403A in alignment with a left eyepiece 402A and a right dimmer 403B in alignment with a right eyepiece 403B. While the examples show dimmers 403 as being positioned on the world side of eyepieces 402, in some embodiments it may be desirable to position dimmers 403 on the user side of eyepieces 402 (on the side closest to the user's eyes).

In FIG. 4A, a set of left dimming values are computed for left dimmer 403A, forming dimmed area 436A, and a set of right dimming values are computed for right dimmer 403B, forming dimmed area 436B, so as to at least partially dim the world light emanating from the light source that is traveling toward the user's left and right eyes, respectively. It can be observed that the positions of dimmed areas 436 differ for dimmers 403 due to positions of the user's eyes relative to the light source. For example, the user's left eye is closer to the light source in the lateral direction than the user's right eye, and as such left dimmed area 436A is more centrally positioned within left dimmer 403A than right dimmed area 436B within right dimmer 403B.

In FIG. 4B, the light source has moved from the left of the user to directly in front of the user. Similar to that described for FIG. 4A, dimming values are computed for left dimmer 403A and right dimmer 403B so as to at least partially dim the world light emanating from the light source that is traveling toward the user's eyes. The positions of dimmed areas 436 again differ for dimmers 403 due to positions of the user's eyes relative to the light source. In FIG. 4C, the light source has moved from in front of the user to the right of the user. Dimming values are again computed for left dimmer 403A and right dimmer 403B so as to at least partially dim the world light emanating from the light source that is traveling toward the user's eyes, resulting in right dimmed area 436B being more centrally positioned within right dimmer 403B and left dimmed area 436A being positioned on the right side of left dimmer 403A.

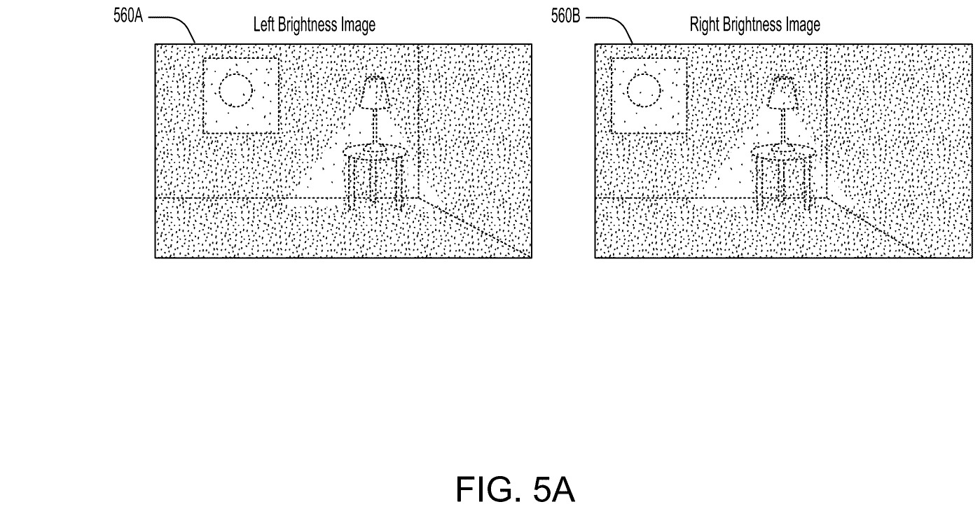

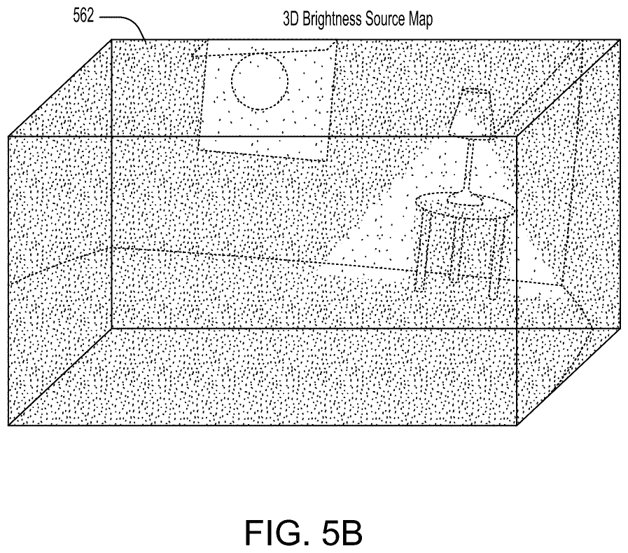

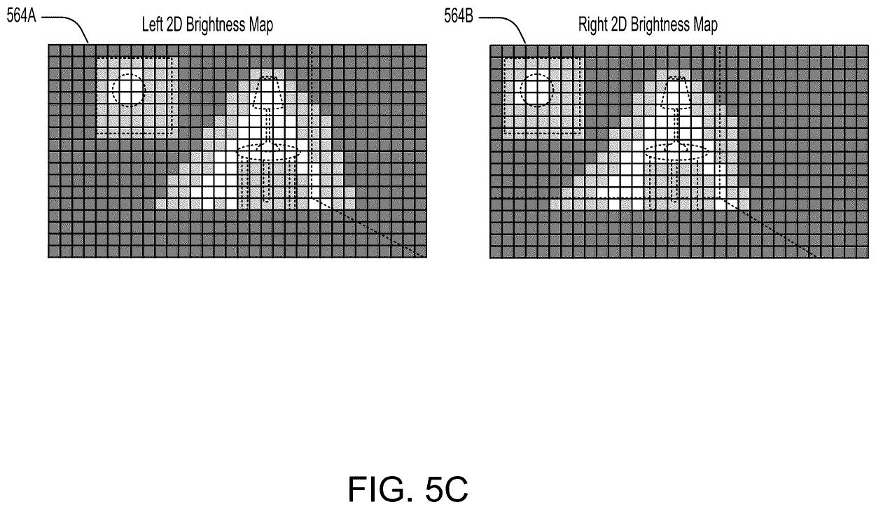

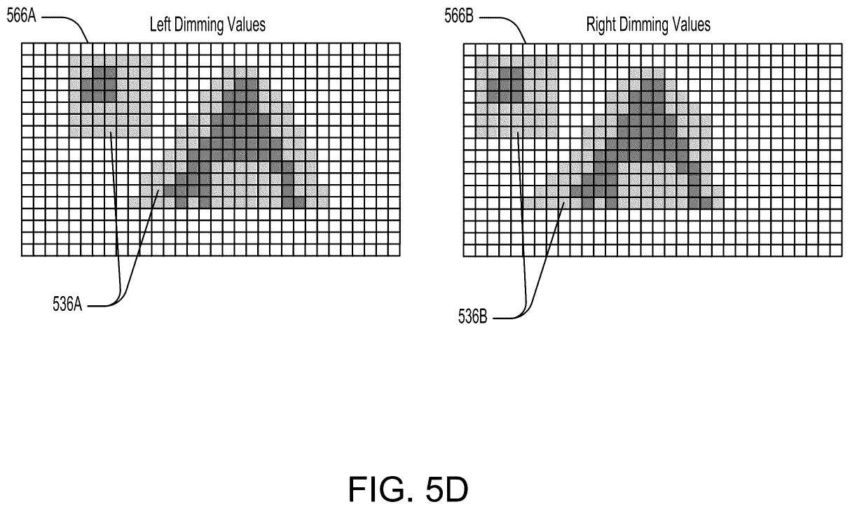

FIGS. 5A-5D illustrate example data that may be captured, generated, or computed to obtain sets of left and right dimming values for dimmers of a wearable device, according to some embodiments of the present disclosure. The illustrated examples correspond to an indoor environment in which the wearable device is oriented toward two main light sources that include the sun visible through a window and a lamp on a table. In FIG. 5A, a left brightness image 560A and a right brightness image 560B are captured by a left camera and a right camera of the wearable device, respectively. The left and right cameras may be positioned near (e.g., on the outside of) the left and right dimmers, respectively, but not in alignment with the dimmers so as to not obscure the user's view of the scene.

In FIG. 5B, a 3D brightness source map 562 is generated based on left brightness image 560A and right brightness image 560B. In some embodiments, 3D brightness source map 562 may indicate the direction and magnitude of different light sources within the scene. For example, 3D brightness source map 562 may include brightness values along one or more surfaces of a 3D shape such as a hexahedron or a hemisphere. In the illustrated example, 3D brightness source map 562 includes brightness values along five surfaces of a hexahedron. In various examples, 3D brightness source map 562 may include brightness values in various configurations to convey 3D information obtained by combining brightness images 560.

In FIG. 5C, a left 2D brightness map 564A and a right 2D brightness map 564B are generated based on 3D brightness source map 562. In some instances, 2D brightness maps 564 may also be generated based on predicted positions of the user's eye such that each of 2D brightness maps 564 corresponds to the brightness values actually experienced by the user's eyes. For example, the position of the user's left eye may be predicted, and left 2D brightness map 564A may be generated so as to represent the actual brightness values experienced by the user's left eye through the surface of the left dimmer, and the position of the user's right eye may be predicted, and right 2D brightness map 564B may be generated so as to represent the actual brightness values experienced by the user's right eye through the surface of the right dimmer.

In FIG. 5D, left diming values 566A and right dimming values 566B are computed based on left 2D brightness map 564A and right 2D brightness map 564B, respectively. In general, higher levels of dimming are computed for areas within the device field of view that have higher brightness values as indicated by 2D brightness maps 564. For example, higher values for left diming values 566A are computed for areas in left 2D brightness map 564A that have higher brightness values, resulting in left dimmed areas 536A, and higher values for right diming values 566B are computed for areas in right 2D brightness map 564B that have higher brightness values, resulting in right dimmed areas 536B.

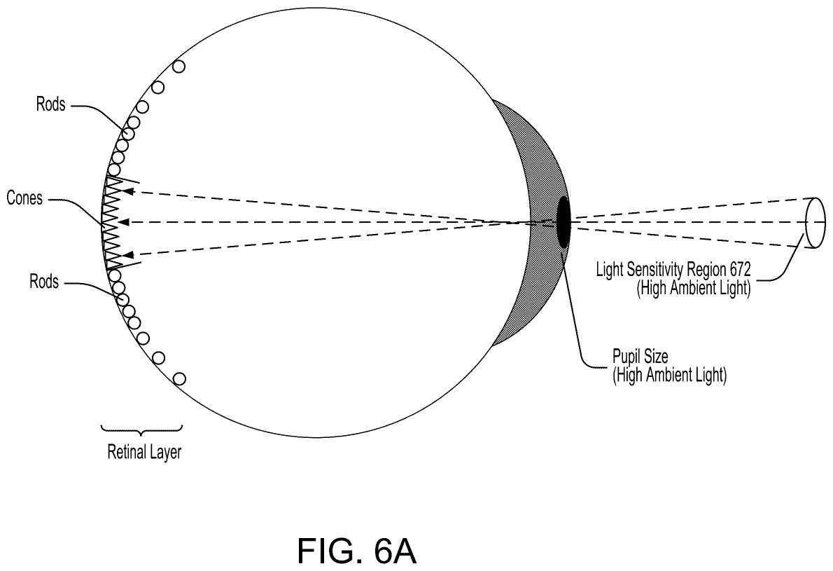

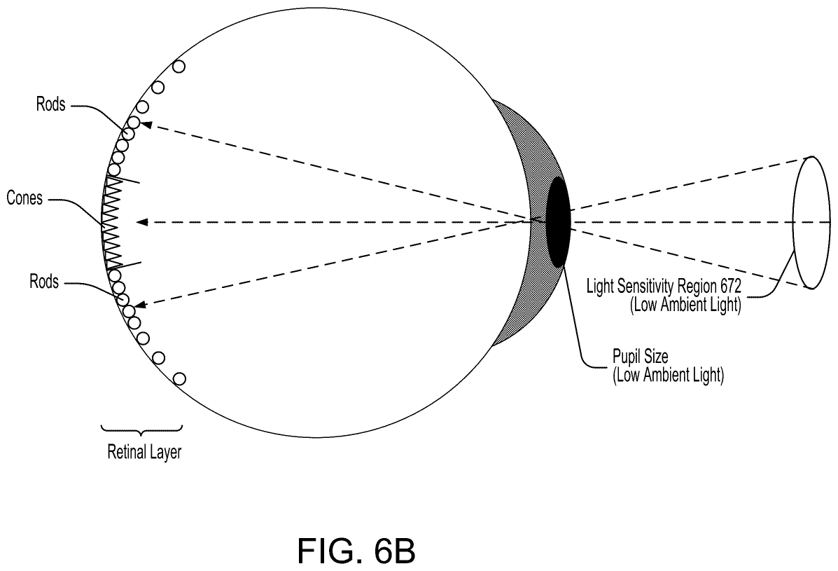

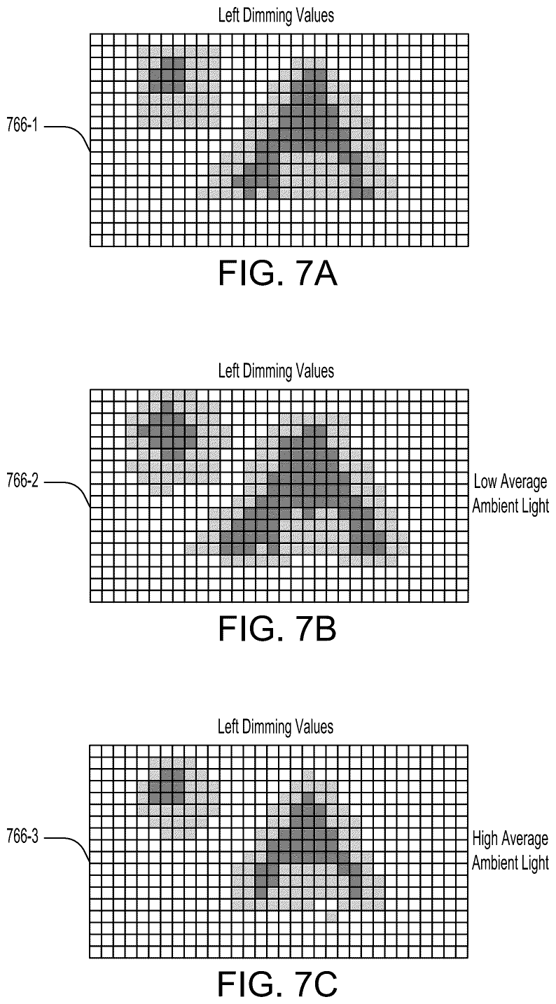

FIGS. 6A and 6B illustrate examples of how a light sensitivity region 672 of an eye can change in high and low ambient light, according to some embodiments of the present disclosure. Because cones are more sensitive to light in high light conditions and rods are more sensitive to light in low light conditions, as the average ambient light decreases, the fronts of light sensitive vectors (indicated in FIGS. 6A and 6B by dashed lines) can move from a center position of the retinal layer corresponding to a high density of cones outward to an annulus corresponding to a high density of rods. Accordingly, light sensitivity region 672 formed by the source points of the light sensitive vectors is larger in low ambient light compared to high ambient light. FIGS. 6A and 6B further demonstrate how the pupil dilates and constricts in light and high ambient light, respectively, allowing the corresponding light sensitive vectors to pass therethrough. As described in reference to FIGS. 7A-7C, this phenomenon can be leveraged when computing dimming values to increase the effectiveness of the dimming.

FIGS. 7A-7C illustrate how computed dimming values can be modified based on the ambient light conditions to improve the effectiveness of the dimming, according to some embodiments of the present disclosure. Dimming values 755 shown in FIG. 7A may correspond to left dimming values 566A computed in FIG. 5D. In some embodiments, an average ambient light may be detected by the wearable device and may be used to modify dimming values 766-1. The average ambient light may be detected using a dedicated ambient light sensor or using the brightness images, the 3D brightness source map, and/or the 2D brightness maps.

As an example, in FIG. 7B, when low average ambient light is detected (e.g., the average ambient light is below a threshold), the dimmed areas formed by dimming values 766-1 may be spread out to compensate for a larger light sensitivity region of the eye (as described in FIGS. 6A and 6B) to obtain dimming values 766-2. In some embodiments, this may be accomplished using a blurring filter (e.g., by convolving dimming values 766-1 with a blurring filter). As another example, in FIG. 7C, when high average ambient light is detected (e.g., the average ambient light is above a threshold), the dimmed areas formed by dimming values 766-1 may be narrowed to compensate for a smaller light sensitivity region of the eye to obtain dimming values 766-3. In some embodiments, this may be accomplished using a sharpening filter (e.g., by convolving dimming values 766-1 with a sharpening filter).

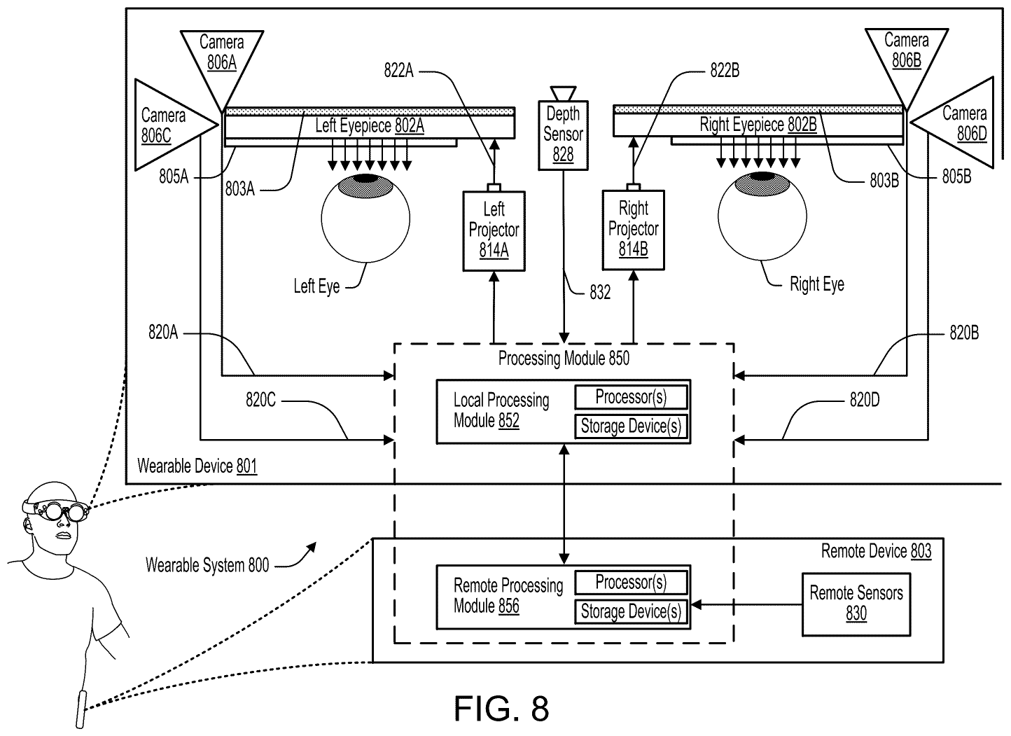

FIG. 8 illustrates a schematic view of an example wearable system 800, according to some embodiments of the present disclosure. Wearable system 800 may include a wearable device 801 and at least one remote device 803 that is remote from wearable device 801 (e.g., separate hardware but communicatively coupled). Wearable system 800 may alternatively be referred to as an “optical system”, and wearable device 801 may alternatively be referred to as an “optical device”. While wearable device 801 is worn by a user (generally as a headset), remote device 803 may be held by the user (e.g., as a handheld controller) or mounted in a variety of configurations, such as fixedly attached to a frame, fixedly attached to a helmet or hat worn by a user, embedded in headphones, or otherwise removably attached to a user (e.g., in a backpack-style configuration, in a belt-coupling style configuration, etc.).

Wearable device 801 may include a left eyepiece 802A, a left lens assembly 805A, and a left segmented dimmer 803A arranged in a side-by-side configuration and constituting a left optical stack. Left lens assembly 805A may include an accommodating lens on the user side of the left optical stack as well as a compensating lens on the world side of the left optical stack.

Similarly, wearable device 801 may include a right eyepiece 802B, a right lens assembly 805B, and a right segmented dimmer 803B arranged in a side-by-side configuration and constituting a right optical stack. Right lens assembly 805B may include an accommodating lens on the user side of the right optical stack as well as a compensating lens on the world side of the right optical stack.

In some embodiments, wearable device 801 includes one or more sensors including, but not limited to: a left front-facing world camera 806A attached to the side of left dimmer 803A, a right front-facing world camera 806B attached to the side of right dimmer 803B, a left side-facing world camera 806C attached directly to or near left eyepiece 802A, a right side-facing world camera 806D attached directly to or near right eyepiece 802B, and a depth sensor 828 attached between eyepieces 802. Wearable device 801 may include one or more image projection devices such as a left projector 814A optically linked to left eyepiece 802A and a right projector 814B optically linked to right eyepiece 802B.

Wearable system 800 may include a processing module 850 for collecting, processing, and/or controlling data within the system. Components of processing module 850 may be distributed between wearable device 801 and remote device 803. For example, processing module 850 may include a local processing module 852 on the wearable portion of wearable system 800 and a remote processing module 856 physically separate from and communicatively linked to local processing module 852. Each of local processing module 852 and remote processing module 856 may include one or more processing units (e.g., central processing units (CPUs), graphics processing units (GPUs), etc.) and one or more storage devices, such as non-volatile memory (e.g., flash memory).

Processing module 850 may collect the data captured by various sensors of wearable system 800, such as cameras 806, depth sensor 828, remote sensors 830, ambient light sensors, microphones, eye tracking cameras, inertial measurement units (IMUs), accelerometers, compasses, Global Navigation Satellite System (GNSS) units, radio devices, and/or gyroscopes. For example, processing module 850 may receive image(s) 820 from cameras 806. Specifically, processing module 850 may receive left front image(s) 820A from left front-facing world camera 806A, right front image(s) 820B from right front-facing world camera 806B, left side image(s) 820C from left side-facing world camera 806C, and right side image(s) 820D from right side-facing world camera 806D. In some embodiments, image(s) 820 may include a single image, a pair of images, a video comprising a stream of images, a video comprising a stream of paired images, and the like. Image(s) 820 may be periodically generated and sent to processing module 850 while wearable system 800 is powered on, or may be generated in response to an instruction sent by processing module 850 to one or more of the cameras.

Cameras 806 may be configured in various positions and orientations along the outer surface of wearable device 801 so as to capture images of the user's surrounding. In some instances, cameras 806A, 806B may be positioned to capture images that substantially overlap with the FOVs of a user's left and right eyes, respectively. Accordingly, placement of cameras 806 may be near a user's eyes but not so near as to obscure the user's FOV. Alternatively or additionally, cameras 806A, 806B may be positioned so as to align with the incoupling locations of virtual image light 822A, 822B, respectively. Cameras 806C, 806D may be positioned to capture images to the side of a user, e.g., in a user's peripheral vision or outside the user's peripheral vision. Image(s) 820C, 820D captured using cameras 806C, 806D need not necessarily overlap with image(s) 820A, 820B captured using cameras 806A, 806B.

In some embodiments, processing module 850 may receive ambient light information from an ambient light sensor. The ambient light information may indicate a brightness value or a range of spatially-resolved brightness values. Depth sensor 828 may capture a depth image 832 in a front-facing direction of wearable device 801. Each value of depth image 832 may correspond to a distance between depth sensor 828 and the nearest detected object in a particular direction. As another example, processing module 850 may receive eye tracking data 834 from eye tracking cameras 826, which may include images of the left and right eyes. As another example, processing module 850 may receive projected image brightness values from one or both of projectors 814. Remote sensors 830 located within remote device 803 may include any of the above-described sensors with similar functionality.

Virtual content is delivered to the user of wearable system 800 using projectors 814 and eyepieces 802, along with other components in the optical stacks. For instance, eyepieces 802A, 802B may comprise transparent or semi-transparent waveguides configured to direct and outcouple light generated by projectors 814A, 814B, respectively. Specifically, processing module 850 may cause left projector 814A to output left virtual image light 822A onto left eyepiece 802A, and may cause right projector 814B to output right virtual image light 822B onto right eyepiece 802B. In some embodiments, projectors 814 may include micro-electromechanical system (MEMS) spatial light modulator (SLM) scanning devices. In some embodiments, each of eyepieces 802A, 802B may comprise a plurality of waveguides corresponding to different colors. In some embodiments, lens assemblies 805A, 805B may be coupled to and/or integrated with eyepieces 802A, 802B. For example, lens assemblies 805A, 805B may be incorporated into a multi-layer eyepiece and may form one or more layers that make up one of eyepieces 802A, 802B.

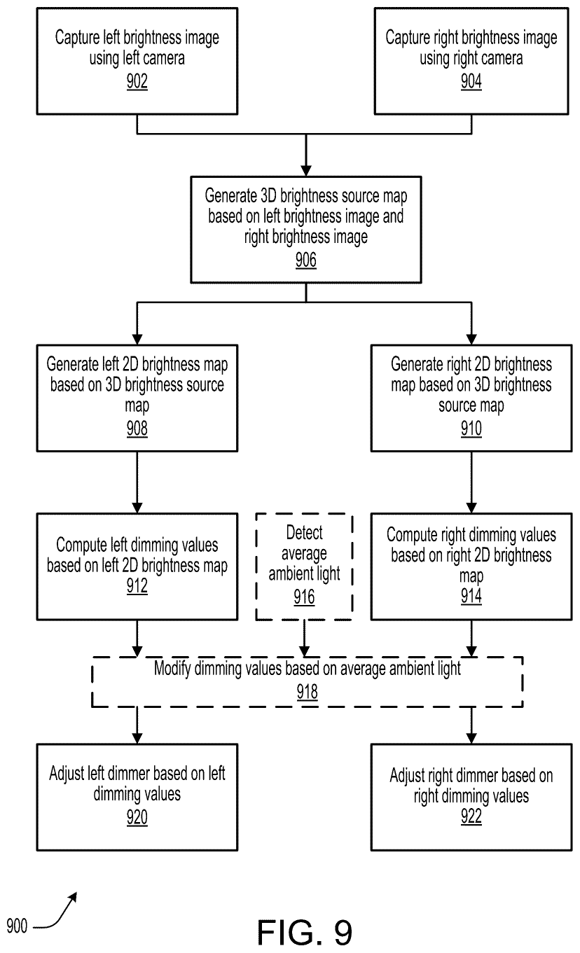

FIG. 9 illustrates a method 900 of operating an optical system, in accordance with some embodiments of the present disclosure. One or more steps of method 900 may be omitted during performance of method 900, and steps of method 900 may be performed in any order and/or in parallel. One or more steps of method 900 may be performed by one or more processors, such as those included in the optical system. Method 900 may be implemented as a computer-readable medium or computer program product comprising instructions which, when the program is executed by one or more computers, cause the one or more computers to carry out the steps of method 900.

The optical system described in relation to method 900 may correspond to a wearable system (e.g., wearable system 800) and/or a wearable device (e.g., wearable devices 101, 201, 301, 801) as described in various embodiments. The optical system described in relation to method 900 may be a display device such as an AR device or, in some examples, the optical system may be device without capabilities to display virtual content, such as a pair of sunglasses. The optical system may include a left dimmer (e.g., dimmers 203, 303, 403A, 803A) and a right dimmer (e.g., dimmers 203, 303, 403B, 803B). The optical system may be configured to receive world light (e.g., world light 132, 232) associated with a world object (e.g., world objects 130, 230) at each of the left dimmer and the right dimmer.

At steps 902, a left brightness image (e.g., left brightness image 560A) is captured using a left camera (e.g., cameras 206, 806A) of the optical system. The left camera may capture multi-channel images that are converted into the left brightness image or the left camera may directly capture the left brightness image. The left brightness image may include brightness values as observed from the perspective of the left camera. The left camera may be laterally offset from the left dimmer.

At steps 904, a right brightness image (e.g., right brightness image 560B) is captured using a right camera (e.g., cameras 206, 806B) of the optical system. The right camera may capture multi-channel images that are converted into the right brightness image or the right camera may directly capture the right brightness image. The right brightness image may include brightness values as observed from the perspective of the right camera. The right camera may be laterally offset from the right dimmer.

At steps 906, a 3D brightness source map (e.g., 3D brightness source map 562) is generated based on the left brightness image and the right brightness image. The 3D brightness source map may be generated further based on a known or predetermined distance (e.g., the lateral distance) between the left camera and the right camera. The 3D brightness source map may indicate directions and magnitudes of different light sources within the field of view of the optical system. In some embodiments, the 3D brightness source map may indicate the 3D positions of the different light sources. In some embodiments, the 3D brightness source map may include brightness values as observed from the perspective of a 3D reference point. The 3D reference point may be along the optical system (e.g., directly between the left dimmer and the right dimmer).

At steps 908, a left 2D brightness map (e.g., left 2D brightness map 564A) is generated based on the 3D brightness source map. The left 2D brightness map may be generated further based on a predicted position of the user's left eye with respect to the 3D reference point. The left 2D brightness map may include brightness values as observed from the perspective of the user's left eye and/or the left dimmer.

At steps 910, a right 2D brightness map (e.g., right 2D brightness map 564B) is generated based on the 3D brightness source map. The right 2D brightness map may be generated further based on a predicted position of the user's right eye with respect to the 3D reference point. The right 2D brightness map may include brightness values as observed from the perspective of the user's right eye and/or the right dimmer.

At steps 912, left dimming values (e.g., left dimming values 566A) are computed for a left dimmer based on the left 2D brightness map. The left dimming values may form one or more left dimmed areas (e.g., dimmed areas 236, 436A, 536A), which may be the portions of the field of view of the optical system that are to be at least partially dimmed. The left dimming values may be computed from the left 2D brightness map using a proportional dimming scheme, a threshold dimming scheme, among other possibilities.

At steps 914, right dimming values (e.g., right dimming values 566B) are computed for a right dimmer based on the right 2D brightness map. The right dimming values may form one or more right dimmed areas (e.g., dimmed areas 236, 436B, 536B), which may be the portions of the field of view of the optical system that are to be at least partially dimmed. The right dimming values may be computed from the right 2D brightness map using a proportional dimming scheme, a threshold dimming scheme, among other possibilities.

At steps 916, optionally, an average ambient light is detected. The average ambient light may be detected using a dedicated ambient light sensor or using the left and right brightness images, the 3D brightness source map, and/or the left and right 2D brightness maps.

At steps 918, optionally, the left dimming values and/or the right dimming values are modified based on the average ambient light. For example, when the average ambient light is determined to be below a first threshold, the dimmed areas formed by the left dimming values and/or the right dimming values may be spread out to compensate for a larger light sensitivity region of the eyes. As another example, when the average ambient light determined to be above a second threshold (e.g., different than and greater than the first threshold) the dimmed areas formed by the left dimming values and/or the right dimming values may be narrowed to compensate for a smaller light sensitivity region of the eyes.

At steps 920, the left dimmer is adjusted based on the left dimming values so as to reduce an intensity of the light associated with the world object. The left dimmer may be adjusted further based on a left calibration map that indicates a voltage level for each pixel in the left dimmer that is to be applied to achieve a particular dimming level.

At steps 922, the right dimmer is adjusted based on the right dimming values so as to reduce an intensity of the light associated with the world object. The right dimmer may be adjusted further based on a right calibration map that indicates a voltage level for each pixel in the right dimmer that is to be applied to achieve a particular dimming level.

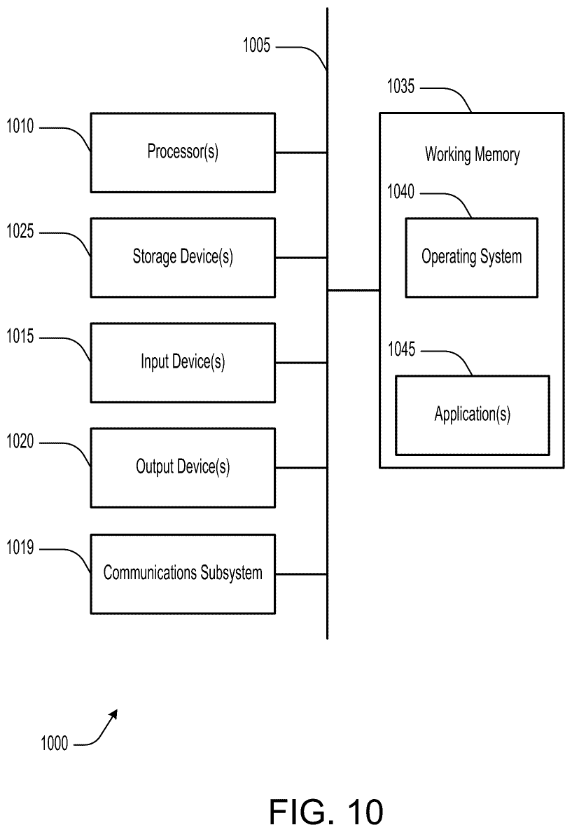

FIG. 10 illustrates an example computer system 1000 comprising various hardware elements, in accordance with some embodiments of the present disclosure. Computer system 1000 may be incorporated into or integrated with devices described herein and/or may be configured to perform some or all of the steps of the methods provided by various embodiments. For example, in various embodiments, computer system 1000 may be incorporated into wearable system 800 and/or may be configured to perform method 900. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

In the illustrated example, computer system 1000 includes a communication medium 1002, one or more processor(s) 1004, one or more input device(s) 1006, one or more output device(s) 1008, a communications subsystem 1010, and one or more memory device(s) 1012. Computer system 1000 may be implemented using various hardware implementations and embedded system technologies. For example, one or more elements of computer system 1000 may be implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device, such as an SoC FPGA, among other possibilities.

The various hardware elements of computer system 1000 may be communicatively coupled via communication medium 1002. While communication medium 1002 is illustrated as a single connection for purposes of clarity, it should be understood that communication medium 1002 may include various numbers and types of communication media for transferring data between hardware elements. For example, communication medium 1002 may include one or more wires (e.g., conductive traces, paths, or leads on a printed circuit board (PCB) or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 1002 may include one or more buses connecting pins of the hardware elements of computer system 1000. For example, communication medium 1002 may include a bus that connects processor(s) 1004 with main memory 1014, referred to as a system bus, and a bus that connects main memory 1014 with input device(s) 1006 or output device(s) 1008, referred to as an expansion bus. The system bus may itself consist of several buses, including an address bus, a data bus, and a control bus. The address bus may carry a memory address from processor(s) 1004 to the address bus circuitry associated with main memory 1014 in order for the data bus to access and carry the data contained at the memory address back to processor(s) 1004. The control bus may carry commands from processor(s) 1004 and return status signals from main memory 1014. Each bus may include multiple wires for carrying multiple bits of information and each bus may support serial or parallel transmission of data.

Processor(s) 1004 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 1004 may include one or more multi-core processors, in which each core may read and execute program instructions concurrently with the other cores, increasing speed for programs that support multithreading.

Input device(s) 1006 may include one or more of various user input devices such as a mouse, a keyboard, a microphone, as well as various sensor input devices, such as an image capture device, a pressure sensor (e.g., barometer, tactile sensor), a temperature sensor (e.g., thermometer, thermocouple, thermistor), a movement sensor (e.g., accelerometer, gyroscope, tilt sensor), a light sensor (e.g., photodiode, photodetector, charge-coupled device), and/or the like. Input device(s) 1006 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 1008 may include one or more of various devices that convert information into human-readable form, such as without limitation a display device, a speaker, a printer, a haptic or tactile device, and/or the like. Output device(s) 1008 may also include devices for writing to removable storage devices or other removable media, such as those described in reference to input device(s) 1006. Output device(s) 1008 may also include various actuators for causing physical movement of one or more components. Such actuators may be hydraulic, pneumatic, electric, and may be controlled using control signals generated by computer system 1000.

Communications subsystem 1010 may include hardware components for connecting computer system 1000 to systems or devices that are located external to computer system 1000, such as over a computer network. In various embodiments, communications subsystem 1010 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 1012 may include the various data storage devices of computer system 1000. For example, memory device(s) 1012 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 1004 and memory device(s) 1012 are illustrated as being separate elements, it should be understood that processor(s) 1004 may include varying levels of on-processor memory, such as processor registers and caches that may be utilized by a single processor or shared between multiple processors.

Memory device(s) 1012 may include main memory 1014, which may be directly accessible by processor(s) 1004 via the memory bus of communication medium 1002. For example, processor(s) 1004 may continuously read and execute instructions stored in main memory 1014. As such, various software elements may be loaded into main memory 1014 to be read and executed by processor(s) 1004 as illustrated in FIG. 10. Typically, main memory 1014 is volatile memory, which loses all data when power is turned off and accordingly needs power to preserve stored data. Main memory 1014 may further include a small portion of non-volatile memory containing software (e.g., firmware, such as BIOS) that is used for reading other software stored in memory device(s) 1012 into main memory 1014. In some embodiments, the volatile memory of main memory 1014 is implemented as RAM, such as dynamic random-access memory (DRAM), and the non-volatile memory of main memory 1014 is implemented as read-only memory (ROM), such as flash memory, erasable programmable read-only memory (EPROM), or electrically erasable programmable read-only memory (EEPROM).

Computer system 1000 may include software elements, shown as being currently located within main memory 1014, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 1016, which are executable by computer system 1000. In one example, such instructions 1016 may be received by computer system 1000 using communications subsystem 1010 (e.g., via a wireless or wired signal that carries instructions 1016), carried by communication medium 1002 to memory device(s) 1012, stored within memory device(s) 1012, read into main memory 1014, and executed by processor(s) 1004 to perform one or more steps of the described methods. In another example, instructions 1016 may be received by computer system 1000 using input device(s) 1006 (e.g., via a reader for removable media), carried by communication medium 1002 to memory device(s) 1012, stored within memory device(s) 1012, read into main memory 1014, and executed by processor(s) 1004 to perform one or more steps of the described methods.

In some embodiments of the present disclosure, instructions 1016 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 1000. For example, the non-transitory computer-readable medium may be one of memory device(s) 1012 (as shown in FIG. 10). In some cases, the non-transitory computer-readable medium may be separate from computer system 1000. In one example, the non-transitory computer-readable medium may be a removable medium provided to input device(s) 1006 (as shown in FIG. 10), such as those described in reference to input device(s) 1006, with instructions 1016 being read into computer system 1000 by input device(s) 1006. In another example, the non-transitory computer-readable medium may be a component of a remote electronic device, such as a mobile phone, that may wirelessly transmit a data signal that carries instructions 1016 to computer system 1000 and that is received by communications subsystem 1010 (as shown in FIG. 10).

Instructions 1016 may take any suitable form to be read and/or executed by computer system 1000. For example, instructions 1016 may be source code (written in a human-readable programming language such as Java, C, C++, C#, Python), object code, assembly language, machine code, microcode, executable code, and/or the like. In one example, instructions 1016 are provided to computer system 1000 in the form of source code, and a compiler is used to translate instructions 1016 from source code to machine code, which may then be read into main memory 1014 for execution by processor(s) 1004. As another example, instructions 1016 are provided to computer system 1000 in the form of an executable file with machine code that may immediately be read into main memory 1014 for execution by processor(s) 1004. In various examples, instructions 1016 may be provided to computer system 1000 in encrypted or unencrypted form, compressed or uncompressed form, as an installation package or an initialization for a broader software deployment, among other possibilities.

In one aspect of the present disclosure, a system (e.g., computer system 1000) is provided to perform methods in accordance with various embodiments of the present disclosure. For example, some embodiments may include a system comprising one or more processors (e.g., processor(s) 1004) that are communicatively coupled to a non-transitory computer-readable medium (e.g., memory device(s) 1012 or main memory 1014). The non-transitory computer-readable medium may have instructions (e.g., instructions 1016) stored therein that, when executed by the one or more processors, cause the one or more processors to perform the methods described in the various embodiments.

In another aspect of the present disclosure, a computer-program product that includes instructions (e.g., instructions 1016) is provided to perform methods in accordance with various embodiments of the present disclosure. The computer-program product may be tangibly embodied in a non-transitory computer-readable medium (e.g., memory device(s) 1012 or main memory 1014). The instructions may be configured to cause one or more processors (e.g., processor(s) 1004) to perform the methods described in the various embodiments.

In another aspect of the present disclosure, a non-transitory computer-readable medium (e.g., memory device(s) 1012 or main memory 1014) is provided. The non-transitory computer-readable medium may have instructions (e.g., instructions 1016) stored therein that, when executed by one or more processors (e.g., processor(s) 1004), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure.

For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of operating an optical system, the method comprising:
receiving, at the optical system, light associated with a world object;
capturing a left brightness image and a right brightness image using a left camera and a right camera of the optical system, respectively;
generating a 3D brightness source map based on the left brightness image and the right brightness image;
generating a left 2D brightness map and a right 2D brightness map based on the 3D brightness source map;
computing left dimming values and right dimming values based on the left 2D brightness map and the right 2D brightness map, respectively; and
adjusting a left dimmer and a right dimmer of the optical system based on the left dimming values and the right dimming values, respectively, so as to reduce an intensity of the light associated with the world object.

2. The method of claim 1, further comprising:
projecting virtual image light onto a left eyepiece and a right eyepiece of the optical system.

3. The method of claim 2, wherein the left dimmer and the right dimmer are positioned on a world side of the left eyepiece and the right eyepiece, respectively.

4. The method of claim 2, wherein the left dimmer and the right dimmer are positioned on a user side of the left eyepiece and the right eyepiece, respectively.

5. The method of claim 1, wherein the left camera and the right camera directly capture multi-channel images that are converted into the left brightness image and a right brightness image, respectively.

6. The method of claim 1, wherein the left camera and the right camera directly capture the left brightness image and the right brightness image, respectively.

7. The method of claim 1, wherein the left dimming values and the right dimming values indicate portions of a field of view of the optical system that are to be at least partially dimmed by the left dimmer and the right dimmer, respectively.

8. The method of claim 1, wherein the 3D brightness source map is further generated based on a predetermined distance between the left camera and the right camera.

9. The method of claim 1, wherein generating the left 2D brightness map and the right 2D brightness map based on the 3D brightness source map includes predicting positions of a user's left eye and a user's right eye, respectively, with respect to the 3D brightness source map when the optical system is in use.

10. A non-transitory computer-readable medium comprising instructions that, when executed by one or more processors, cause the one or more processors to perform operations for operating an optical system, the operations comprising:
capturing a left brightness image and a right brightness image using a left camera and a right camera of the optical system based on receiving light associated with a world object, respectively;
generating a 3D brightness source map based on the left brightness image and the right brightness image;
generating a left 2D brightness map and a right 2D brightness map based on the 3D brightness source map;
computing left dimming values and right dimming values based on the left 2D brightness map and the right 2D brightness map, respectively; and
adjusting a left dimmer and a right dimmer of the optical system based on the left dimming values and the right dimming values, respectively, so as to reduce an intensity of the light associated with the world object.

11. The non-transitory computer-readable medium of claim 10, wherein the operations further comprise:
projecting virtual image light onto a left eyepiece and a right eyepiece of the optical system.

12. The non-transitory computer-readable medium of claim 11, wherein the left dimmer and the right dimmer are positioned on a world side of the left eyepiece and the right eyepiece, respectively.

13. The non-transitory computer-readable medium of claim 10, wherein the left camera and the right camera directly capture multi-channel images that are converted into the left brightness image and a right brightness image, respectively.

14. The non-transitory computer-readable medium of claim 10, wherein the left dimming values and the right dimming values indicate portions of a field of view of the optical system that are to be at least partially dimmed by the left dimmer and the right dimmer, respectively.

15. The non-transitory computer-readable medium of claim 10, wherein the 3D brightness source map is further generated based on a predetermined distance between the left camera and the right camera.

16. The non-transitory computer-readable medium of claim 10, wherein generating the left 2D brightness map and the right 2D brightness map based on the 3D brightness source map includes predicting positions of a user's left eye and a user's right eye, respectively, with respect to the 3D brightness source map when the optical system is in use.

17. An optical system comprising,
a left camera and a right camera configured to capture a left brightness image and a right brightness image, respectively;
a left dimmer and a right dimmer configured to reduce an intensity of light associated with a world object in accordance with left dimming values and right dimming values, respectively; and
one or more processors communicatively coupled to the left camera, the right camera, the left dimmer, and the right dimmer, wherein the one or more processors are configured to:
generate a 3D brightness source map based on the left brightness image and the right brightness image;
generate a left 2D brightness map and a right 2D brightness map based on the 3D brightness source map;
compute the left dimming values and the right dimming values based on the left 2D brightness map and the right 2D brightness map, respectively; and
adjust the left dimmer and the right dimmer based on the left dimming values and the right dimming values, respectively, so as to reduce the intensity of the light associated with the world object.

18. The optical system of claim 17, further comprising:
a left eyepiece and a right eyepiece in alignment with the left dimmer and the right dimmer, respectively.

19. The optical system of claim 18, wherein the one or more processors are configured to project virtual image light onto the left eyepiece and the right eyepiece.

20. The optical system of claim 18, wherein the left dimmer and the right dimmer are positioned on a world side of the left eyepiece and the right eyepiece, respectively.
